(19) United States
(12) Patent Application Publication
(10) Pub. No.: US 2019/0087893 A1
(43) Pub. Date: Mar. 21, 2019

(54) Methods and Systems for Blockchain Based Segmented Risk Based Securities

(71) Applicant: Othera Pty Ltd, Sydney (AU)

(72) Inventor: John Pellew, Sydney (AU)

(21) Appl. No.: 16/098,952

(22) PCT Filed: Sep. 5, 2016
(86) PCT No.: PCT/AU2016/050840

§ 371 Date: Nov. 5, 2018

(30) Foreign Application Priority Data
May 6, 2016 (AU) 2016901674

(51) Int. Cl. G06Q 40/02; G06Q 40/06; G06Q 40/04; G06Q 20/38; G06Q 20/04; G06Q 20/10; H04L 9/32; H04L 9/06

(52) U.S. Cl. CPC G06Q 40/025; G06Q 40/06; G06Q 40/04; G06Q 20/3825; H04L 2209/38; G06Q 20/102; H04L 9/3247; H04L 9/0637; G06Q 20/04

(57) ABSTRACT

A method of providing for a secure financial transaction, the method including the steps of: (a) formulating the documentation associated with the financial transaction, including security for the transaction; (b) dividing the transaction into a series of segments, each segment having an associated expected risk profile and security profile; (c) for each segment, creating an indicative token describing the segment, including associated expected risk profile and security profile; (d) providing a block chain environment for storage of the indicative tokens.

### FIELD OF THE INVENTION

The present invention relates to the field of the creation of automated Segmented Risk Based Securities, utilising a secure cryptographic based validation system. The invention also relates to the creation of a new class of financial assets.

### BACKGROUND OF THE INVENTION

A number of traditional forms of loan type arrangements exist. These include: Corporate Bonds; Syndicated Loans; Securitized Loans, Fractional Loans issued by marketplace lenders using different Credit risk assessment models and credit risk pricing models

An example of the semi automation of complex loan arrangements and Fractional Loans issued by marketplace lenders; and Credit risk assessment models and credit risk pricing models is disclosed in United States Patent Application No: 2014/0067650, entitled “Methods and Systems for Consumer Lending”, the contents of which are hereby incorporated by cross reference.

Corporate Bonds: By way of background summary Corporate Bonds are generally created or issued by large companies as a mechanism to raise debt finance for their company from the “public” (can also be issued by Medium and Small companies, but is not often done, so due to cost and complexity). These corporate bonds, once issued, are sold to investors via brokers or financial institutions or on exchanges to investors. The traditional corporate bond is a term debt instrument in the eyes of the issuer and an investment product in the eyes of the purchaser (investor). To issue a Corporate Bond, apart from regulatory issues, the borrower needs to have a credit rating from one of the official credit ratings agencies such as Moody's or Standard and Poor's. The higher (better) the credit rating the lower the Interest the company will need to pay on the bond. Companies with a less than perfect credit rating (ie not investment grade) are classed and “Junk” hence the term Junk Bonds and would be required to pay and higher Interest Rate to purchasers (investors) of the bond. Corporate bonds are generally issued to raise debt funds in the $50 m+ range of fund due to the time, cost and complexity of the process. Traditional corporate bonds do not come with a guarantee of repayment and the sales brokers and the institutions and advisors involved in the issue are not responsible to the investor for managing the loan facility or repayments. There are no capital repayments over the life of the bond, so they are like an interest only loan up until the date they are due from full repayment. Traditional Corporate Bonds can/are still issued in paper form. Traditional Corporate Bonds may be traded electronically and are called exchange traded corporate bonds, but are no different to paper traded corporate bonds.

Other, non exhaustive characteristics of the Corporate Bonds is that they have: a credit rating, a fixed face value, a coupon (Interest Rate) and a Term ie a period of time after which the bond (loan) must be repaid to investors and the timing of interest payments.

Syndicated Loan: A syndicated loan is a loan extended to a single customer by multiple financial institutions, which are formed into a group, or “syndicate”, for that purpose. The same terms and conditions apply to all of the lenders in the syndication and there is only one loan agreement. FIG. 1 illustrates schematically the arrangement and the transaction flow 10 of a typical Syndicated Loan. The arranger 11 (Mizuho Bank) serves as contact point for all parties, including customer 12 and syndicate lenders 13, negotiates lending terms, and arranges the syndicate. After the loan agreement is signed, the agent 11 (Mizuho Bank) takes responsibility for handling the various administrative tasks (such as processing loan applications, assigning loan portions, and disbursing principal and interest payments to the other syndicate members). Generally only very large loans are capable of being syndicated or require syndication due both the cost, complexity and timeframes involved in doing the due diligence. Ie loans in the $100's of millions of dollars. Syndicate members 13 are almost exclusively other banks. Syndicate loans are formed to share the lending risk across a number of banks due to the scale of the loans sort.

Securitised Loans: Securitization is the process of taking an illiquid asset, or group of assets, and through financial engineering, transforming them into a security. A typical example of securitization is a Mortgage Backed Security (MBS), which is a type of Asset Backed Security that is secured by a collection of mortgages. FIG. 2 illustrates the general flow 20 of a securitization process.

First, a regulated and authorized financial institution originates numerous mortgages, which are secured by claims against the various properties the mortgages purchase. Then, all of the individual mortgages are bundled together into a mortgage pool, which is held in trust as the collateral for an MBS. The MBS can be issued by a third-party financial company, such a large investment banking firm, or by the same bank that originated the mortgages in the first place. The result is a new security is created, backed up by the claims against the mortgagor's assets. This security can be sold to participants in the secondary mortgage market. This market is extremely large, providing a significant amount of liquidity to the group of mortgages, which otherwise would have been quite illiquid on their own. Furthermore, at the time the MBS is being created, the issuer will often choose to break the mortgage pool into a number of different parts, referred to as tranches. These tranches can be structured in virtually any way the issuer sees fit, allowing the issuer to tailor a single MBS for a variety of risk tolerances. Pension funds will typically invest in high-credit rated mortgage-backed securities, while hedge funds will seek higher returns by investing in those with low credit ratings.

One of the biggest challenges to the continued growth and confidence in the peer-2-peer or marketplace lending as an investment opportunity is the availability of a viable, fast and transparent secondary market for the fractional loans in which investors make investments. To date there are a number of platform specific marketplaces, that are slow and lack market depth (liquidity) there are also a number of external exchanges being created, but the vehicle they use to make the trading possible is slow, clunky and expensive.

Lack of liquidity in the secondary market for fractional loans being issued by the marketplace lending models has been cited and a big concern for investors and significantly adds to the risk of the investment. Some of the largest marketplace lender are now offering small secondary market for their own fractional loans, but the pricing and structure of the sales have high cost, high levels of transactional friction and low liquidity. More recently there has been some activity in trying to securitize many of these fractional loans, but again this is slow, costly and not and “on demand” solution for investors.

Since the Global Financial Crisis (GFC) in 2008 there has been a long term decline in the returns achievable in the marketplace on “retail” type investment with cash rates at an all time low in 2015-2016. This means there is a problem for the aging population and the need to generate income from saving at a retail level. With the exception of shares and marketplace fractional loans, there are very few alternatives to achieving better than the average market returns on investments while still investing in markets with high liquidity. The problem is that virtually all investment intended for retail consumption are “vanilla” ie one size fits all and can not be tailored to the individual client investment needs ie risk vs return.

With the exception of the small secondary markets for marketplace lending fractional loans mentioned above there is no established, proven and actively traded secondary market for any other retail type investment.

### SUMMARY OF THE INVENTION

It is an object of the invention, in its preferred form to provide an improved form of secure financial transactions.

In accordance with a first aspect of the present invention, there is provided a method of providing for a secure financial transaction, the method including the steps of: (a) formulating the documentation associated with the financial transaction, including security for the transaction; (b) dividing the transaction into a series of segments, each segment having an associated expected risk profile, security profile and/or price profile; (c) for each segment, creating an indicative token describing the segment, including associated expected risk profile, security profile and representing the rights to future cash flows associated with the payments under the financial transaction as attributed to each segment (d) providing a blockchain environment for storage of the indicative tokens

The step (d) further can comprise utilising the blockchain environment for the trading of the indicative tokens. The step (d) further can comprise storing the full transactional history of the transfer of the indicative tokens.

In accordance with a further aspect of the present invention, there is provided a method of providing for a secure financial transaction, the method including the steps of: (a) formulating the documentation associated with the financial transaction, (b) creating an encryption hash indicator for the documentation; and (c) storing the encryption hash indicator in a blockchain as evidence of the transaction.

In accordance with a further aspect of the present invention, there is provided a financial asset class, denoted a Segmented Risk Based Securities (SRBS), the asset including: a physical loan of a financial resource; a physical loan agreement governing the operation of the physical loan; and a Smart Loan Contract Code to mirror the executable elements of the physical loan agreement; and a series of SRBS Tokens (SRBST) stored in a block chain type network representing the rights to the flow of income and principal repayments due under the loan agreement.

The SRBS Tokens are preferably virtual assets backed by physical assets. The SRBS Tokens can represent different segments of risk determined by the level and character of the underlying physical assets used by the borrower to secure the loan. SRBS tokens can represent each discrete risk segment which can be priced using any number of risk based pricing methodologies, expressed as an interest rate (IR). Each risk segment can be assigned a SRBS token or set of tokens to represent the rights to the flow of income and repayment of principal under the loan agreement.

The SRBS Token can be a class of exchange tradable asset.

Provision can be made for the credit risk of the borrower and loan to be periodically re-assessed over the life of the loan and for that credit risk data to be fed back into the Smart Loan Contract Code where it can be tracked and registered on the blockchain as an auditable record of events and view of the credit risk of the investment asset. The financial asset can be dynamically re-priced to the borrower based on the change in credit risk. The full repayment history of the loan can be recorded within the Smart Loan Contract Code and registered on a blockchain as an auditable record of the quality of the repayment performance of the borrower. Optional additional data can be recorded within the Smart Loan Contract Code.

The attributes of the SRBST's are optionally further securitized or syndicated or both securitized and syndicated to create new SRBS's with tailored risk vs reward profiles.

The SRBST can be traded in a primary market ie direct from Issuer to Investor at a fixed price and also traded in a secondary market environment via a range of methods including but not limited to open supply and demand pricing models or exchanges or direct peer-2-peer or brokered sales or some such other method that facilitates a sale and purchase between 2 parties.

The method can further include the step of: segmenting the financial asset into risk based segments based on the estimated level and type of assets provided to secure the loan. The method can also include funding the escrow function of the Smart Loan Contract code by the lender; digitally and securely signing the Smart Loan Contract to execute the agreement and trigger the settlement of the loan, within time limited expiry protocols. The method can also include the step of: automating the creation of loan documents while generating the Smart Contract Loan code in parallel to mirror the executable terms of the agreement.

The embodiments can also include the step of: pricing the notional risk segments and then aggregating the price of each segment to deliver a single price or interest rate for the loan to the borrower. The embodiments can also include creating cryptographic blockchain tokens (SRBS Tokens) to represent the right to income and capital repayments under the financial asset. The SRBS Tokens can represent the right to each risk segment. This allows for utilisation of blockchain technology to register and track the ownership of each SRBS token, and calculating and distributing the income and capital repayments to the token holder at each repayment cycle from the borrower.

The embodiments can also include; providing for borrowers to transact loan repayments with Smart Loan Contract Code re the repayment transaction without the need to manage crypto currency accounts and cross currency transactions external to the repayment process. The embodiments can also include making an automated fiat currency transaction to pass through either existing Crypto Currency or a proprietary value token (PVT) then into the Smart Loan Contract Code for re-distribution out to the SRBS Token holders via existing Crypto Currency or PVT and back into the fiat currency of the SRBS Token holder's choice.

### BRIEF DESCRIPTION OF THE DRAWINGS

Embodiments of the invention will now be described, by way of example only, with reference to the accompanying drawings in which:

FIG. 1 illustrates schematically the arrangement and the transaction flow of a typical Syndicated Loan;

FIG. 2 illustrates schematically a general deal flow in the prior art;

FIG. 3 illustrates a flow chart of the loan application and documentation creation process of an embodiment;

FIG. 4 illustrates a flow chart of the creation and issuance of SRBS and tokens;

FIG. 5 illustrates the process of sale of SRBS tokens by a lender to investors on a token exchange;

FIG. 6 illustrates the loan repayment process utilising token wallets; and

FIG. 7 illustrate the process of segmentation of risk and the creation of tokens for segments.

FIG. 8 to FIG. 14 illustrate alternative flowcharts of an alternative description of an embodiment.

FIG. 15 to FIG. 22 illustrate various control flow diagrams for the processing of transactions.

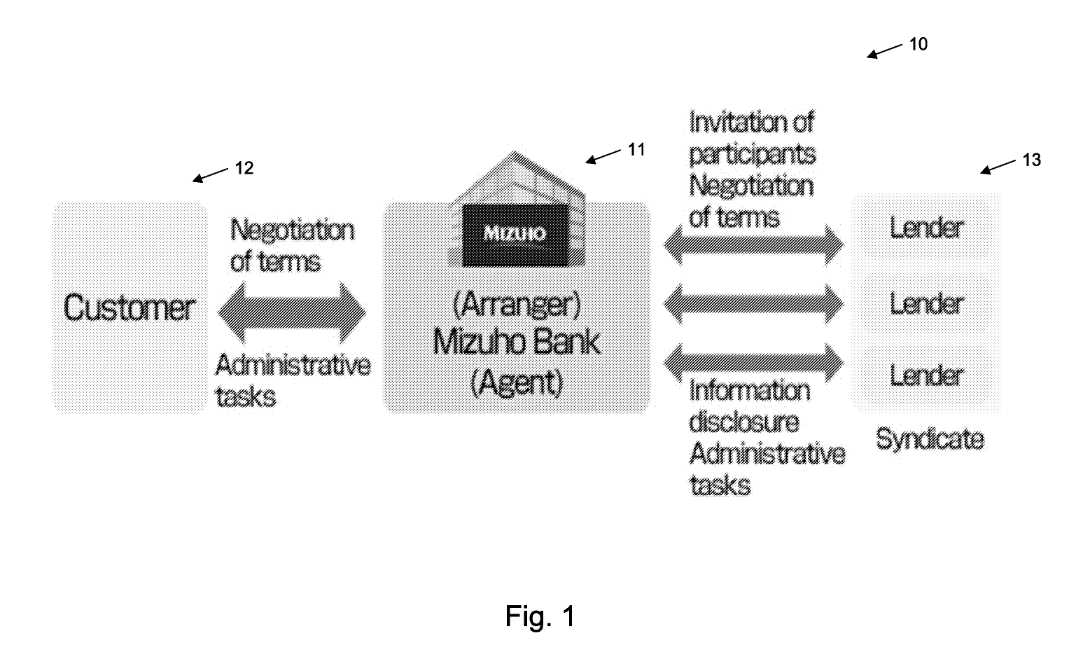

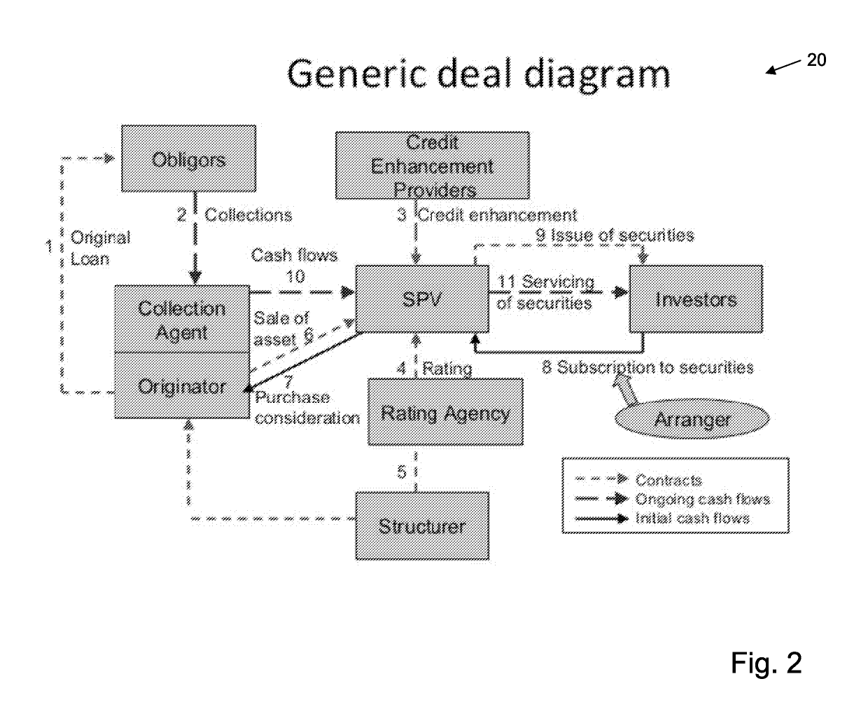

### DETAILED DESCRIPTION

The recent rise of new distributed ledger technology ie Blockchain, distributed ledger, smart contract methodology and tokenization of assets provides an opportunity for the creation of new financial instruments.

The embodiments of the invention provide a new class of exchange tradable asset by combining individual loans, blockchain technology and blockchain Tokens and risk segmentation methods. The blockchain technology can be an adaption of the “Smart Contract” concept originally discussed in the 2013 White paper by Vitalik Buterin entitled: “A Next-Generation Smart Contract and Decentralized Application Platform”, by the Ethereum Organisation and available at: https://github.com/ethereum/wiki/wild/White-Paper), the contents of which are incorporated by cross reference.

The embodiments provide a new class of asset called a Segmented Risk Based Security (SRBS). The SRBS uses blockchain technology such that anyone with a suitable blockchain based wallet and appropriate account can conduct transactions on this security. The new class of asset's ownership rights are linked to a series of Cryptographic Blockchain tokens which represents the right to income flows and principal repayments under the loan contract between a lender (issuer) and borrower.

The loan contract between the borrower and the lender can be executed by an Autonomous Electronic Smart Contract as defined by the Ethereum Organisation whitepaper.

Segmented Risk Based Securities exhibits a number of discrete characteristics, parts of which are found in existing real world financial products ie elements of traditional corporate bonds, syndicated loans and securitised loans, marketplace lending fractional loans a combination of which is only made possible through the use of blockchain technology, Smart Contracts and Blockchain Tokens.

As disclosed hereinafter, the characteristics are enhanced by segmentation of risk within the security into risk tranches which can be discretely priced and then further enhanced by continuously re-rating the risk of the borrower over the life of the loan to allow dynamic re-pricing of the loan based on changes of risk identified.

The embodiments seek to create an investment product that can be easily, quickly and cheaply traded in both primary and secondary markets, with special emphasis on creating a highly liquid secondary market for all types of investments.

The embodiments provide a Segmented Risk Based Security (SRBS) designed, through the technical use of blockchain technologies, to solve the problem of market liquidity for illiquid investments, along with risk transparency and asset provenance for same. The embodiments allow the flexibility for investors to construct their own risk vs return outcomes to best matched investing needs, due to the segmentable risk tranches within the asset each with its own discrete pricing. The embodiments have low transactional friction and cost in the trading process due to the utilisation of blockchain tradable tokens representing the assets.

The SRBS is also designed to deliver in full transparency, the complete transactional history of the assets via the transactional log embedded in the Smart Loan Contract code and registered on the blockchain.

The SRBS is designed specifically to deliver sophisticated investment products and product function and capability, previously available only to the Institutional and wholesale investor to a all types of investor The issuer of the security (the Lender) remains responsible for managing the loan, collection of repayments (either directly or via a special servicer) and retains the customer relationship. The new benefit is that the security and functionality of blockchain technology is applied as a means to provide the removal of the opportunity of vendors to misrepresent the provenance and value of assets for sale. There is no longer a counterparty risk in any transaction regarding the trading of these assets as no transaction can occur without a trustless (ie trust not required) blockchain proof of stake interaction with the asset itself to enable a trade. The SRBS method & process provides to dynamically evaluate the risk of the borrower & loan, with the revised credit data being feed into the loan transactional history for review by token holders and other stakeholders. This allows the loans to be dynamically re-priced if required based on the changing credit risk, transaction or repayment risk of the borrower.

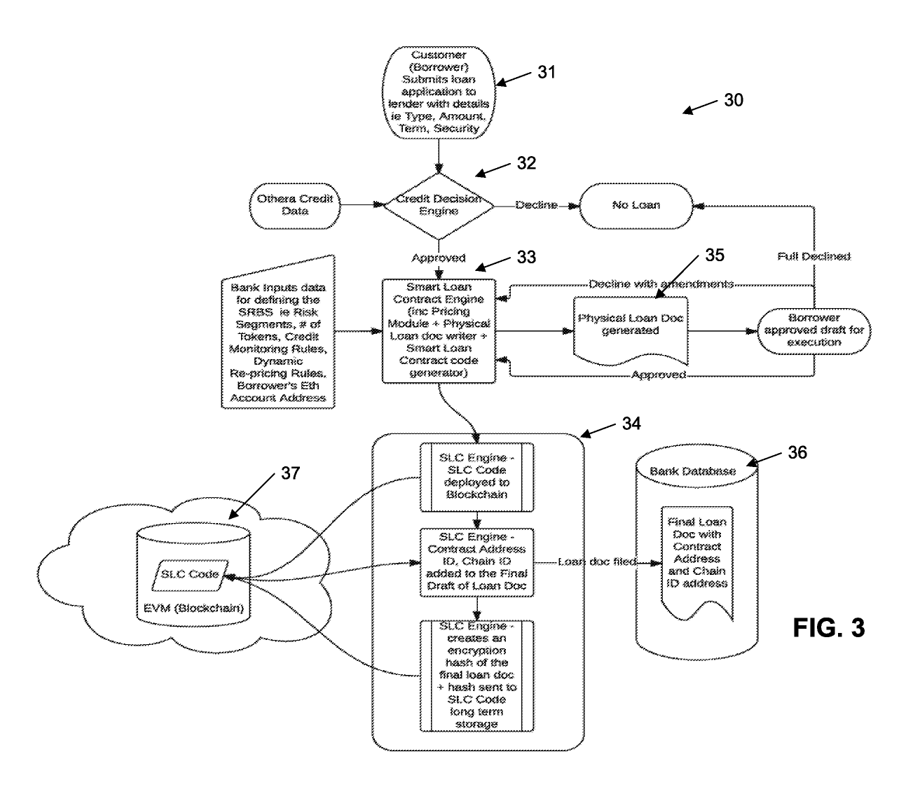

In overview, the embodiments can proceed by the same general structure, as outlined 30 in FIG. 3.

1. A potential borrower makes a loan application 31 for one of many ordinary type loans on offer by his/her bank or specialist lender. These can be a commercial or consumer loan.

2. The credit risk of the loan is assessed 32 by the lender and the loan approved or declined. If the loan is approved the loan is issued via a Smart Loan Contracts platform 33 that both creates the Real World Loan documents 35 and at the same time creates and deploys a bespoke Smart Loan Contract 34 to the blockchain network 37 that mirrors the executable functions of the Loan terms and conditions in their entirety or in part, as circumstances require.

3. Based on the security underpinning the loan, risk segments are created, these risk segments can be grouped to match the projected realisable assets available in the case of a loan default. As an example, one segment might be fully covered by enough assets to payout the whole value of that segment of the loan in the case of default ending in liquidation, while the 2nd segment may have little or no assets to cover a payout in event of a default. The lowest risk segment might then have a different lower pricing to that of the 2nd segment. Price here being represented in terms of Interest Rate

4. The rights to the income and principal repayment flowing from each of the risk segments (there can be any number of risk segments as determined necessary by the lender) are linked to a discrete Token or series of discrete tokens (now labelled SRBS Tokens) with a total aggregate face value of the tokens equal to the face value of the loan at their issuance.

5. These SRBS tokens are initially issued to the lender and placed in the Lender's Blockchain wallet 37. Once in the lender's wallet, they can be marketed for sale to investors at a price to be determined by the lender (now Issuer). The Issuer can choose to sell some of all of the SRBS tokens Investors now have the choice to buy any amount of SRBS tokens representing any risk segment or any combination of risk segment from any specific SRBS transaction to create the best fit combination of risk vs return for their investing needs and if desired leverage up or down the returns possible.

Once purchased the SRBS tokens are transferred from the Issuers wallet to the Investors wallet with all transactions recorded on the blockchain and available for audit with total transparency at all times. Because the SRBS is executed by a Blockchain Smart Contact, the owner of the SRBS token can interrogate the Smart Contract direct for an update on risk and transactional history without the intervention of the Issuer or any other party. Over the life of the loan, the borrower's credit risk rating, behavioural risk rating and transactional risk rating can be re-accessed and updated to the Smart Loan Contract code and archived on the blockchain. The periodical update of the “risk” rating of borrower and hence loan can then be dynamically re-priced for risk Once in the possession of the Investor, the SRBS tokens can be resold at any time to any buyer willing to pay the market price for the SRBS token. Again with each token making it's credit risk and repayment transactional history available for the buyer to inspect and assess before purchase.

In summary therefore: the Segmented Risk Based Securities (SRBS) provides a new class of investment asset which has the following features:

First there must be a loan upon which to base the SRBS, the loan can be any type of loan. The significance is that the virtual assets (SRBS) are backed by a real assets ie loans. Each loan has its own distinct risk and income profile. The virtual assets linked to the real assets can have risk profile and income stream “re-engineered” via the software code to deliver not one outcome, but a range of different outcomes.

The SRBS is a virtual structured finance product, that utilises blockchain technology to ensure veracity. The Smart Contract function of the Ethereum platform, or any platform with smart contract capability, is used to execute the code and record the existence of the SRBS and associated rights tokens on the blockchain.

The SRBS can contain the following elements: 1. The issuance of a nominated number of SRBS tokens linked to each loan contract. 2. The assignment of specific risk segment to each discrete SRBS token created. 3. The definition of how the SRBS and related SRBS tokens can be interacted with by stakeholders. The software also defines an initial face or nominal value of each token. The system defines how loan repayments received by the Smart Contract code are distributed to the SRBS token holders, based on the Risk Segment ascribed to each token and its associated pricing (Interest Rate). The system defines whether the terms of the code can be modified, how and by whom. A blockchain consensus voting model can be used to verify or validated changes to the code. The system defines how and how many tokens can be sold and to whom. The system defines the fees paid to the network and to the loan manager and or the Lender. The system defines what data feeds are used to monitor the credit risk of the borrower and hence the loan. The system defines how that price of the risk segments might be dynamically adjusted based on outcomes. The system defines the penalties for non-compliance of the borrower with the terms or the loan agreement.

These are all elements that define the profile and the characteristics of the SRBS and SRBS tokens. This is not an exhaustive list of ways to define the characteristic as new functions may/will be created over time to enhance or to change the character of the SRBS to suit the specific needs of the investor.

The embodiments provide a new investment product of the nature of small scale loans (but not excluding medium and large loans). This creates a whole new range of investment products that are very flexible in the way they mix and match risk and reward to suit investors specific needs. The embodiments allow for the leveraged segmentation of risk within loans to build investment products that could be tailored to the specific needs of each customer. The embodiments were created to enable the syndication of any size loan and at the same time be able to re-securitize the same loans. The SRBS tokens provide extreme flexibility as an investment product and drive liquidity in the secondary market.

The embodiments provide access to a new class of investment asset where the risk and return can be specifically tailored to each client. The embodiments also provide market liquidity in secondary market for retail type and cash investments. A strong secondary market is well documented to drive investment in the primary and secondary markets for those products

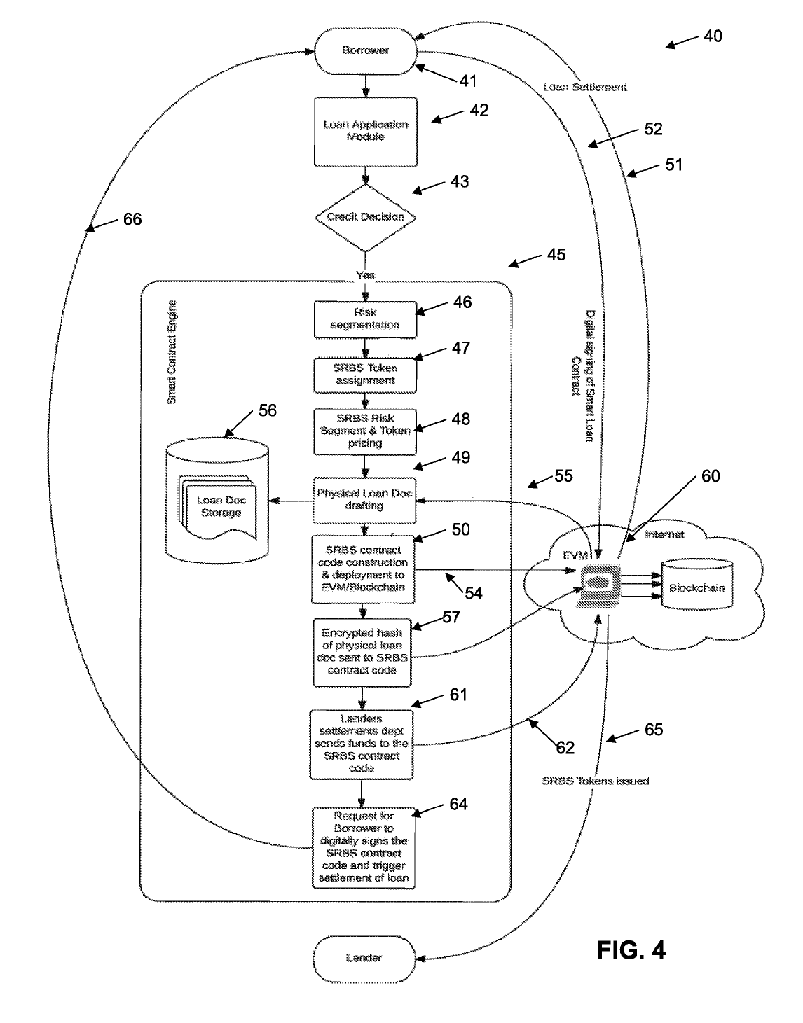

Turning to FIG. 4, there is illustrated a flowchart of a first embodiment 40 which can proceed by the following steps:

A borrower 41 makes a loan application to a lender utilising a loan application module 42 which takes all the relevant information. A credit assessment of the borrower and transaction are done online via an automated credit decision and credit rating engine 43.

If the loan is approved 43, the next step is to push the electronic loan application into the web based Smart Loan Contract Engine 45, which simultaneously constructs real world loan documentation and the Smart Loan Contract code to mirror the executable terms of the loan documentation. Ie Loan Value, Interest rate, term, repayment schedule etc etc. ref all the possible variations of loan contract terms and conditions.

The Smart Loan Contract Engine calculates 46 the risk segments of the loan and the required number of tokens. The Smart Loan Contract Engine then allocates 47 the correct number of tokens to each risk segment. Each group (Tranche) of tokens is labelled with an identifier to identify the risk segment that it belongs to. The Smart Loan Contract Engine then prices 48 the tokens in each Tranche and the aggregated price of the loan is calculated for the loan docs.

Once the final draft of the loan agreement is ready 49, a copy of the draft is sent 51 to the borrower for acceptance. Acceptance is provided by the borrower by providing their blockchain or Ethereum account ID 52, which is then added to the code before the Loan's SLC coded 50 is deployed to the blockchain network. Once deployed the autonomous smart contract code waits until the Borrower signs the acceptance of the loan agreement. Provision is built into the system to set a time limit or expiry before which the Borrower must “sign” the transaction or the transaction will be terminated and the SLC code destroyed, with any funds held by the smart contract code returned to the providers of the funds.

A transaction receipt is sent back 55 to the Smart Loan Contract Engine with the Chain ID and Contract Address which is then inserted into the real world loan documents and stored 56. The loan documents are saved and, an encrypted “hash” of the loan document file is created and the loan documents file is then archived 56.

The unique encrypted hash is then sent 57 as a transaction to the Smart Loan Contract code for the loan with instruction to place the “hash” in the long term storage of the code which is then recorded on the blockchain 59 as a permanent record of the event and the information.

The hash of the real world loan documents can be searched if required and the real world loan documents retrieved from the archive 56. The hashing process can be re run on the loan documents using the same encryption key to do a hash verification. If the hash registered on the blockchain is the same as the re-run hash of the loan documents from the archive then the documents from archive has not been tampered with and is a verifiably accurate version of what was agreed to by the borrower and the lender. These documents can then safely be used as the foundation document in any “real world” legal action, should that be necessary

Once these previous actions have been completed the Smart Loan Contract code is essentially sitting in cyberspace on every node of the blockchain network used to deploy the smart contract. In the example we refer to the Ethereum Blockchain and network (but other Smart Contract enabled blockchain could also be used), so in this case the Smart Loan Contract would sit on each node of the Ethereum Virtual Machine or EVM 60. The code is then waiting to be interacted with ie waiting for instruction on what to do next.

The next step is for the Lender to send 61 the value of the loan to the Smart Loan Contract code using either Ether (ETH) in the example or a proprietary blockchain value token (PVT). The process of sending funds to the Smart Loan Contract Code may involve a currency exchange. The Fiat Currency from the lender account to exchange into ETH or a PVT the ETH or PVT is sent from the Lender's digital blockchain wallet to the Smart Loan Contract code where it is held in escrow until the Borrower complies with the terms of the loan agreement and hence the code.

To “sign” the loan documents 64, the loan documents are presented 66 as a Smart Loan Contract piece of code, the borrower must send a nominal transaction or event 52 to the system to confirm the borrower's identity against the identity already nominated in the Loan Documents on creation and also recorded in the Smart Loan Contract code. If the identities match and the transaction fees are paid the loan goes “live” and the Smart Loan Contract code automatically actions the settlement of the loan and sends the loan funds to the borrower's ETH account or PVT account.

Once the Loan value of ETH/PVT is in the borrower's account, the Lender or another entity or exchange can provide a currency conversion 64 to the borrower's required fiat currency During the settlement, the SRBS tokens are issued 65 to the lender ie sent to lender's ETH/blockchain wallet, which can also hold the special SRBS tokens.

Now that the lender holds the SRBS tokens in their wallet, they need to decide if they want to keep the SRBS tokens or sell some or all of the tokens to investors.

Sale of SBRS Tokens

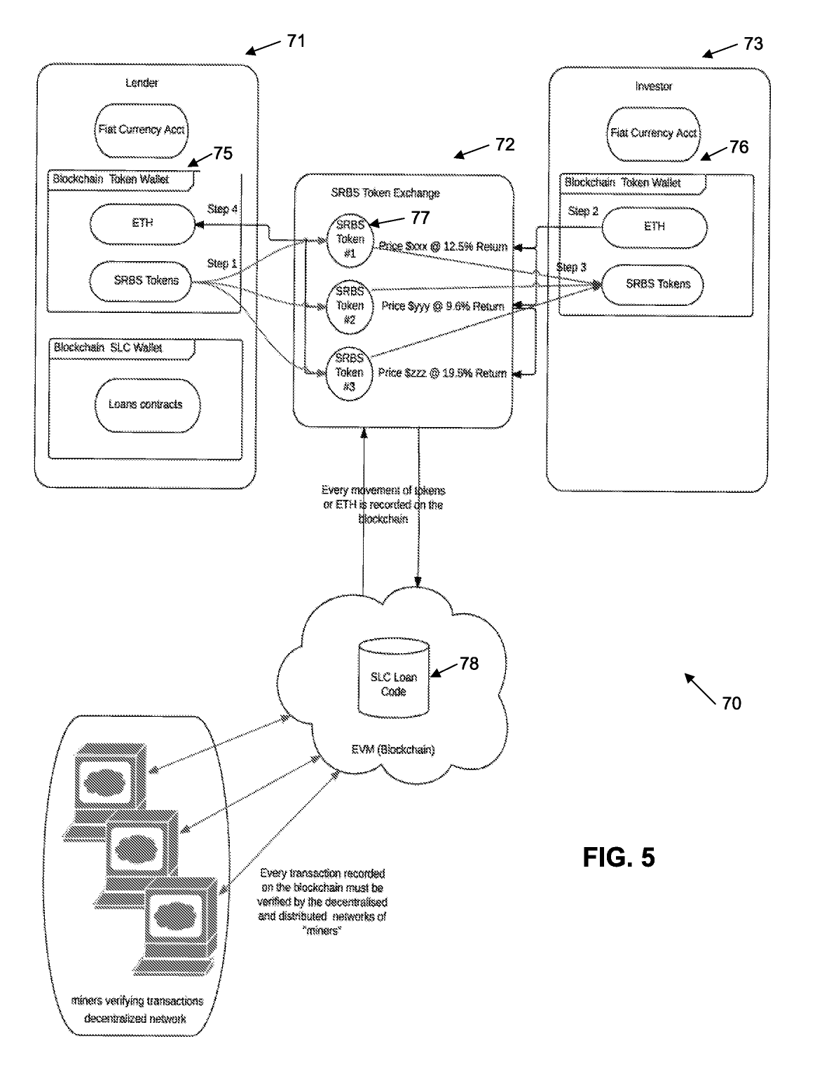

Depending on the policy of the lender or financial markets regulator any portion of the SRBS tokens can be traded or sold. FIG. 5 illustrates one form of arrangement for the sale of SRBS tokens 70. The sale occurs via lenders 71 and investors 73, interacting via a token exchange 72. The sale of SRBS tokens can occur either as a direct sale to investors buying in a primary market ie “New” tokens with no or very limited transactional history. The price of these tokens to the market will most likely be determined as a fixed price. Investors that buy SRBS tokens this way will pay the lender for the tokens and the tokens will be transferred to the Investors ETH/Blockhain wallet 76 where they will be held. Investors can buy any combination of SRBS tokens Ie they can buy a selection of SRBS tokens with different risks and prices to create an investment portfolio that suits their risk vs return needs.

SRBS tokens can also be re-sold in a secondary or exchange traded market place 72. In this situations that prices of SRBS tokens e.g. 77 will be most likely be determined by free market forces ie supply and demand or offer and acceptance. All tokens can be instructed to display their history which is recorded on the blockchain 78 in expectation of just this purpose. As these assets are underpinned by real loans, there are other transactions that are required from the system, including borrowers making periodical repayments, lump sum payments and early payouts of loans. There also a number of admin functions that will also be required ie dealing with late repayment events, default events and executing other conditions of the loan agreement.

Borrower's must make periodic repayment and or bullet type repayments depending on the loan type, but repayments just like any other loan.

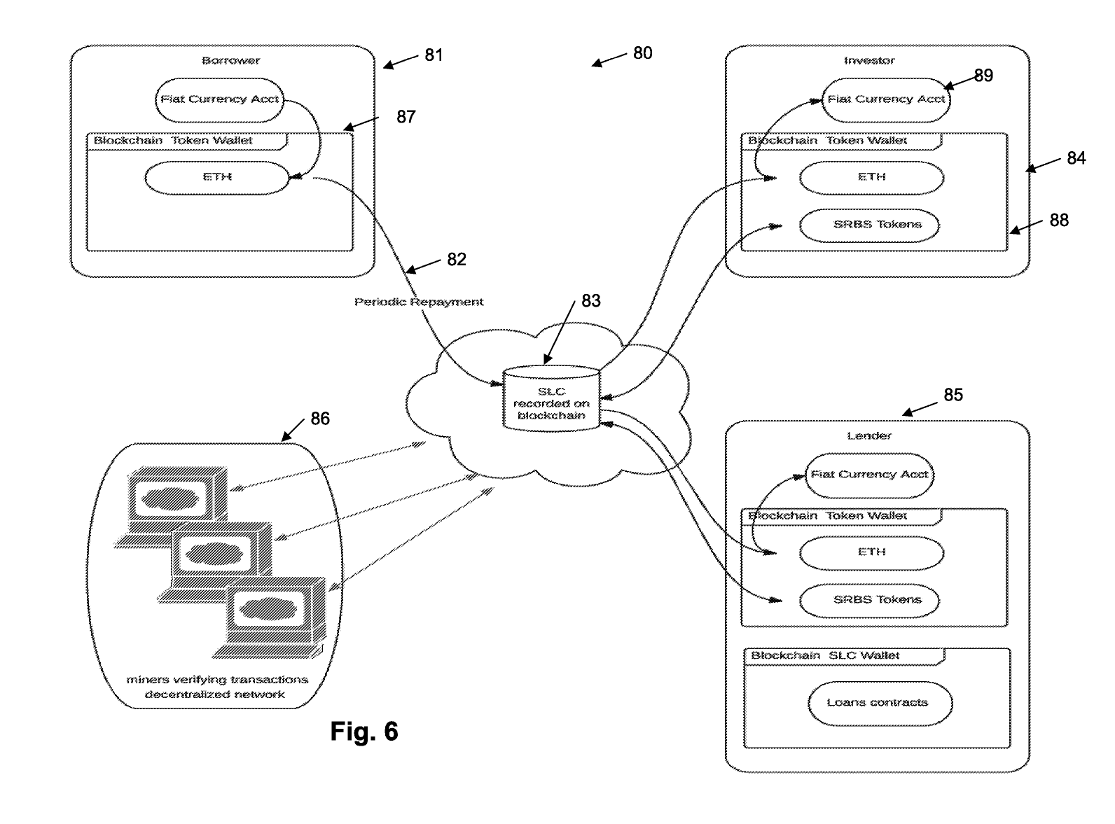

Turning now to FIG. 6, there it illustrates the flow of a repayment. 80. The borrower makes the repayment 82 to the SLC code 83. The SLC code administers and distributes to the SRBS token holders 84, 85. The borrower makes a payment by exchanging the fiat currency value of the repayment into ETH or PVT (this will most likely be facilitated automatically by the bank (lender) during the repayment transaction process 87 which is then sent 82 as a transaction to the SLC code. The SLC code then takes it's fees to run the transaction, and passes the remaining funds to the other stakeholders ie sending fees to the Lender 85 for managing the real world loan and relationship with borrower on behalf of the SRBS token holders 84. The balance of the repayment is then distributed to the remaining SRBS token holders 84 in the proportion appropriate to each specific token. These payments are made automatically from the SLC code to the SRBS token holders ETH or PVT accounts 88. And as previously stated depending on lender the ETH/PVT will most likely be automatically converted back in fiat currency then sent to the SRBS token holder's fiat currency account 89.

Example of late repayment or defaults: There will be cases where there are late payments and defaults. Late repayments may trigger penalty fees or loss recovery under the terms of the loan agreement. The Smart Loan Contract will reflect the real world loan document terms and conditions and can be called to determine if penalties have be triggered, with notifications provided to the borrower by the lender As with traditional loan agreements, if the loan is deemed in default, action can be taken by the lender to recover the value of the defaulted loan from the assets held as security for the loan. In the same way the Smart Loan Contract code can be called to definitively answer the question as to whether the conditions of the loan/SLC Code have been met. If the conditions have not been met the lender can start action to recover losses in the same way they do with traditional loans.

The Smart Loan Contract Code for each loan will have the ability to accept a series of external data feeds. The data feeds the code to answer questions as to whether the conditions of the code (loan) have been met. One of the main objectives here is the dynamic monitoring and re-rating of credit risk, payment behaviours and prediction of default of the borrower. Credit risk data will be fed to the code where it is compared to prior data points. These metrics can be stored on the blockchain within the code and made available for review at a later date or stored off blockchain, but referenced by an encryption hash of the data which is stored on the blockchain.

Depending on the outcome in point 25 it will be possible to use the data about changes in risk to dynamically re-price the loan and or the SRBS Tokens. There are no other “closed loop” pricing systems for financial products in existence.

### An Example Sale Scenario of a SRBS Token.

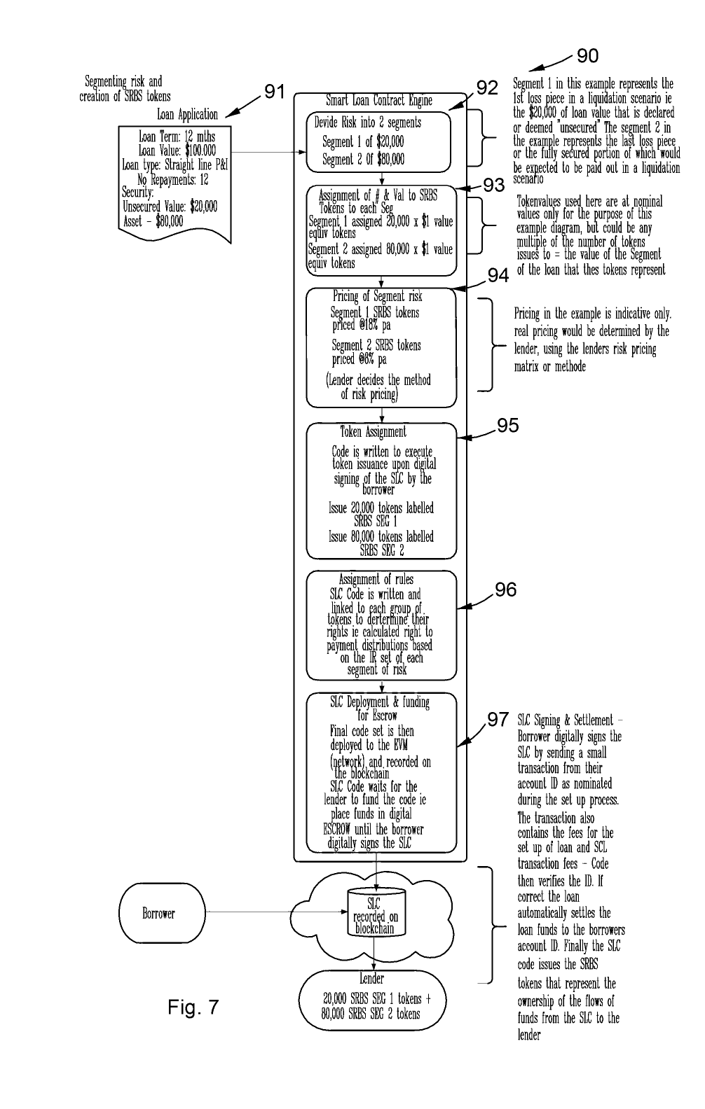

Turning now to FIG. 7, an example sale scenario 90 will now be described. Initially, the number of SRBS tokens will be at the discretion of the lender 91, creator of the SLC and Code. If a $100,000 loan is issued under a SLC then a nominal 100,000 SRBS tokens would have been issued, each representing $1 of loan value.

SRBS tokens will be discretely described a risk segment 92 ranking from “First Loss” to “Last Loss”, the representative scale from first to last might be for example 1 & 2 with the number of risk layers being defined by the types of assets in the security pack securing the actual loan. The lender can determine the number and structure of the risk layers or segments and apply a risk value to each group of SRBS token making up the loan, with each risk group having a different label to distinguish them apart.

For Example, assuming the loan application 91 is for $100,000 secured by $50,000 property assets & $50,000 unsecured. So the 100,000 SRBS tokens might be assigned 93 to the risk values of 1 or 2, 1 being ascribed to the unsecured $50,000 or first loss portion of the loan, and the “safest” portion of the loan $50,000 secured by property asset give risk value 2 or last loss portion. There are a number of methodologies available to allocate the risk of loss rating to each group of SRBS tokens.

Once the risk of loss has been applied to each group of SRBS tokens, the groups of SRBS tokens can be individually priced 94 relative to their associated risk. For example, rating 1 SRBS tokens may be priced initially at 18% pa interest rate, rating 2 SRBS tokens priced at 8% pa This feature of segmented risk on individual loans provides a significant advantage of the embodiment. Any holder of SRBS tokens can decide to re-group or combine together a number of SRBS tokens from many discrete loans or SLC's to create a New Bundled SRBS essentially mimicking elements of the traditional securitization process. The New Bundled SRBS, with its provable risk, payment history and aggregated risk profile can then be marketed for sale and traded. This can happen at any level of investor whether retail or individual or the institutional level and can be traded direct on an exchange or peer-2-peer.

A second example of this operation might be a $120,000 Loan simple Principle and Interest loan over 12 months at 10% pa. The monthly repayment value=$11000, total repayment for the year $132,000. Assuming the loan only has one risk category and only one SRBS token. The investor sees a token with a face value of $120,000 and 10% ROI. The cash flowing from this investment over 12 months is $11,000/mth ie $10,000 principal and $1000 of interest. Now after half of the term of the loan ie 6 mths $60,000 of principal has been repaid along with income of $6,000 in interest. There is now $60,000 of principal still to be repaid and a possible interest of $6,000 (the repayment is still $11,000/mth). If the investor was to sell the SRBS token they could offer it to the market with an asking price of $63,000 ie a premium of $3,000 over face value yet still offering prospective investors a 9.5% pa return on their money. NB: Risk declines as the length of the exposure reduces and also SRBS's have full transparency over the repayment history of the borrower and also any variation in the borrower's credit rating. This can be an attractive deal to an investor.

There is also the useful scenario where the borrower's credit rating or payment history is less than perfect or even in decline. It might still be possible for the seller to recover their initial investment in full by taking a small sacrifice on the overall ROI on the investment ie sell the $60,000 face value investment at a $3000 discount ie at $57,000. Leaving a net profit of $3000 and net ROI of 5% pa. This would mean the security would be offered to the market at $57,000 with a 31.57% pa ROI. This might be very attractive to an investor with a higher appetite for risk.

The loan type can also impact the value of the SRBS in the trading environment. Ie if the original loans are Principal and Interest repayment loans, with the whole loan paid off over the term of the loan then as the loans mature their face value or principal value will decrease, but the periodic repayment will stay the same. So in a trading environment the effective interest rate pa of the SRBS increases over time vs direct principal value. This therefore gives rise to the condition or feature that matured or maturing SRBSs with good prepayment history and stable credit rating attract a premium over the face value. This quality does not exist in any other exchange tradable product on the market today.

### Alternative Embodiments

The concept of the SLC, the SRBS and SRBS tokens have been developed using the Ethereum Smart Contract and tokenizing protocol. Future platforms offering the same tools as smart contracts and tokenizing would allow the construction of the SRBS class of investment assets. Platforms that currently exist or that are in development with smart contract capability include Rootstock, Counterparty and the Linix Foundation Hyperledger project as examples with no doubt more to be developed in the future. The embodiments also have application to other blockchain type security sequences. The core Ethereum platform for Smart Contract and token system could be replaced with an alternative. The payment gateways, could also be substituted for an alternative. The hedging methods, could be changed or omitted, but again not without consequence to the value proposition of risk. The credit scoring data feed could be replaced or omitted but would erode the value and increase the risk of the investment. The live monitoring of risk data feed could be replaced with an alternate risk monitoring data feed or omitted but it was potentially erode the value of the investment and or increase the risk of the investment.

### Further Alternative Embodiment

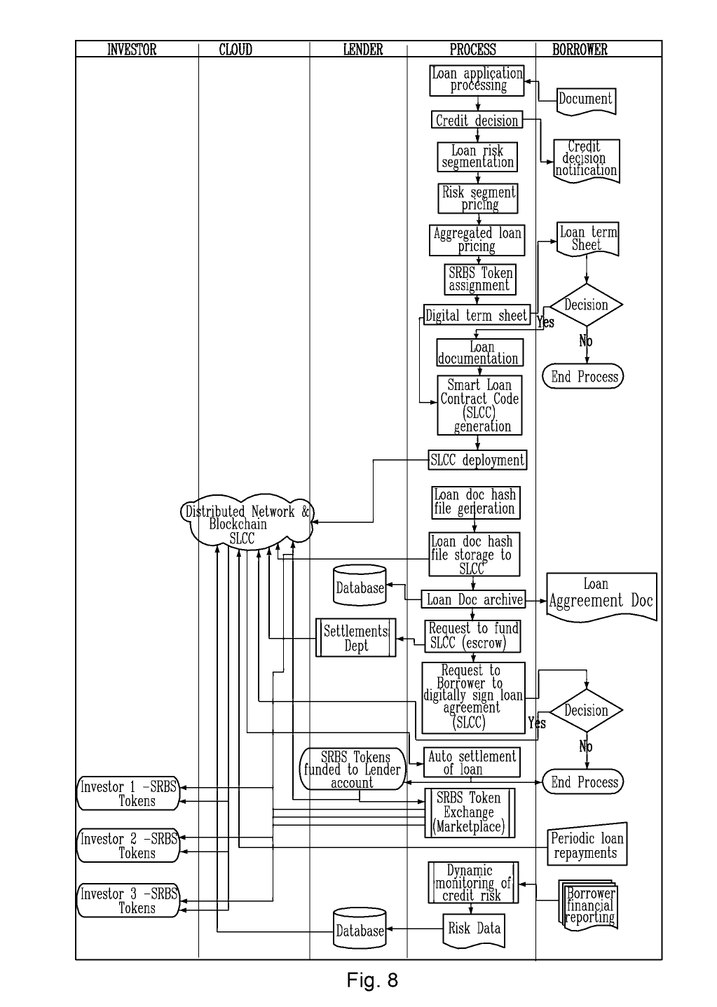

In order to further illustrate the operation of the embodiments, a further alternative description of an embodiment will now be provided with reference to the flowcharts of FIG. 8 to FIG. 14.

In this arrangement, FIG. 8 presents 100 a flow diagram of the overall segmented risk based security process as a high level process.

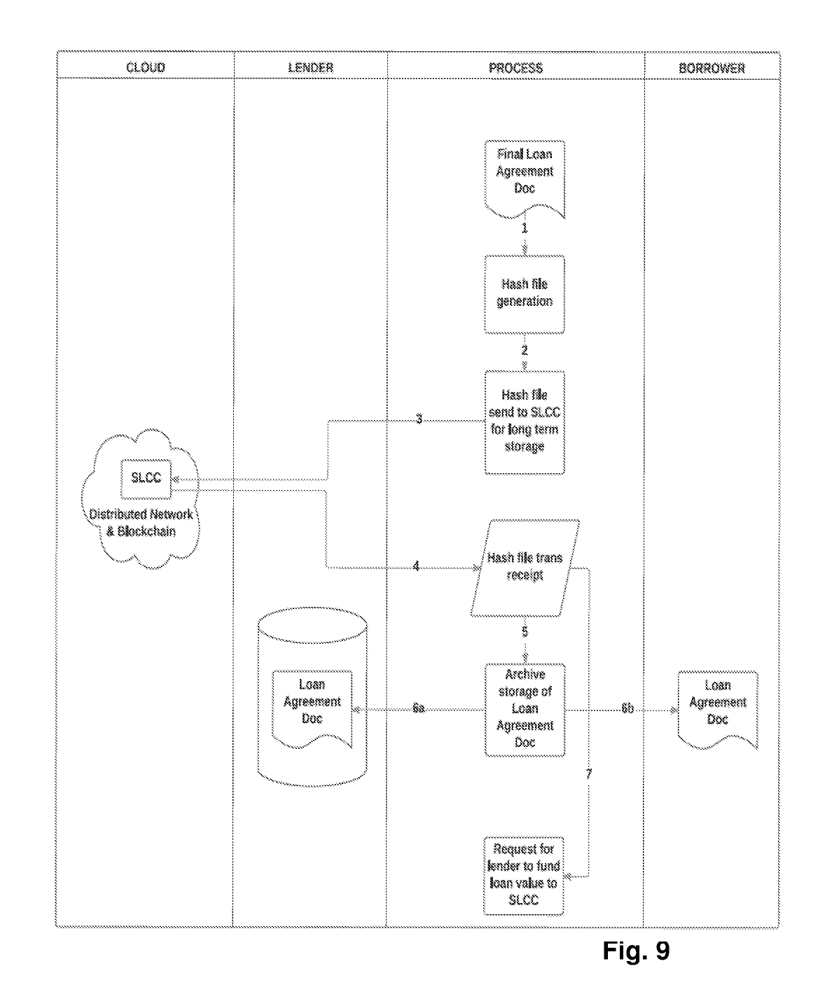

FIG. 9 illustrates in more detail the flow diagram of the loan document generation and validation process, including the storage of a hash file receipt of the loan documents in the block chain.

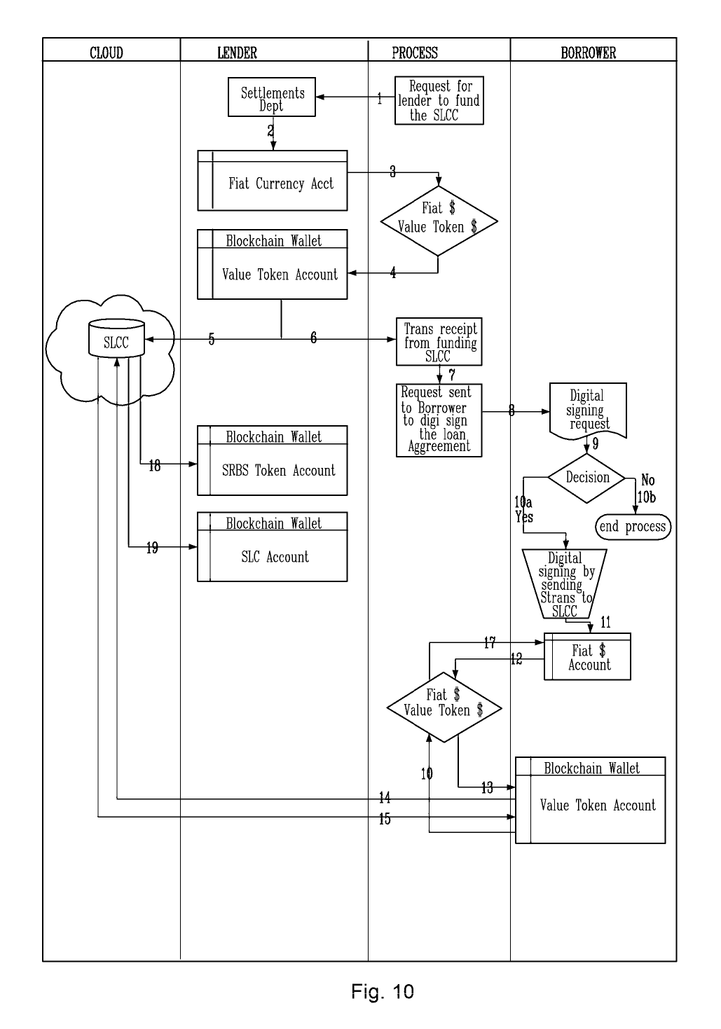

FIG. 10 illustrates the loan settlement process, including the creation of digital tokens as part of the block chain and for trading.

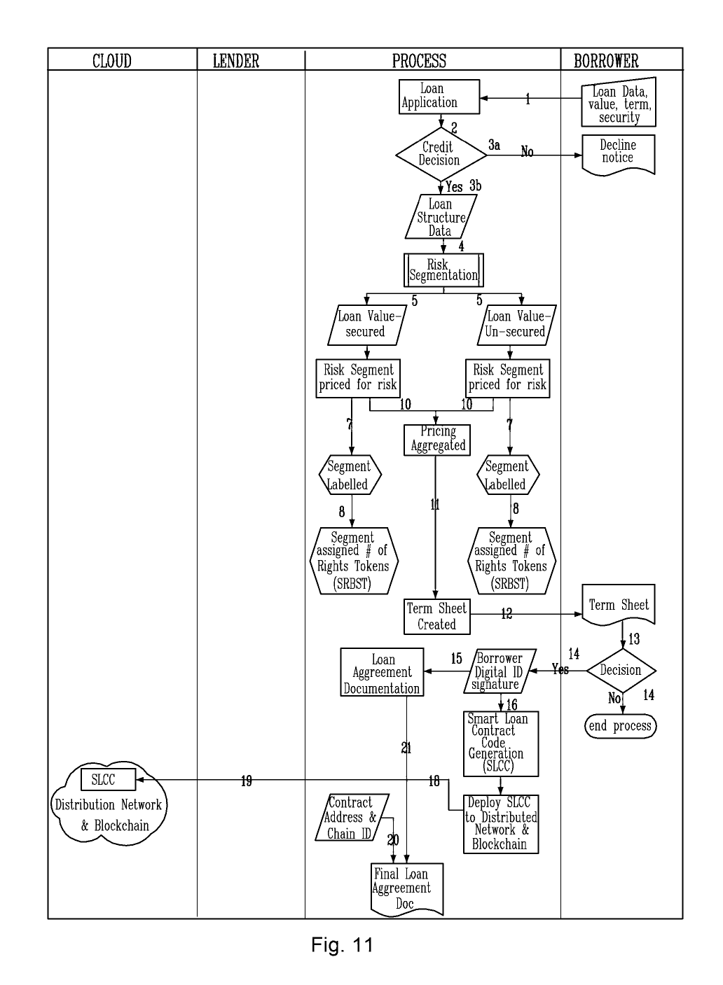

FIG. 11 illustrates a flowchart of the process of loan risk segmentation and creation of segmented tokens.

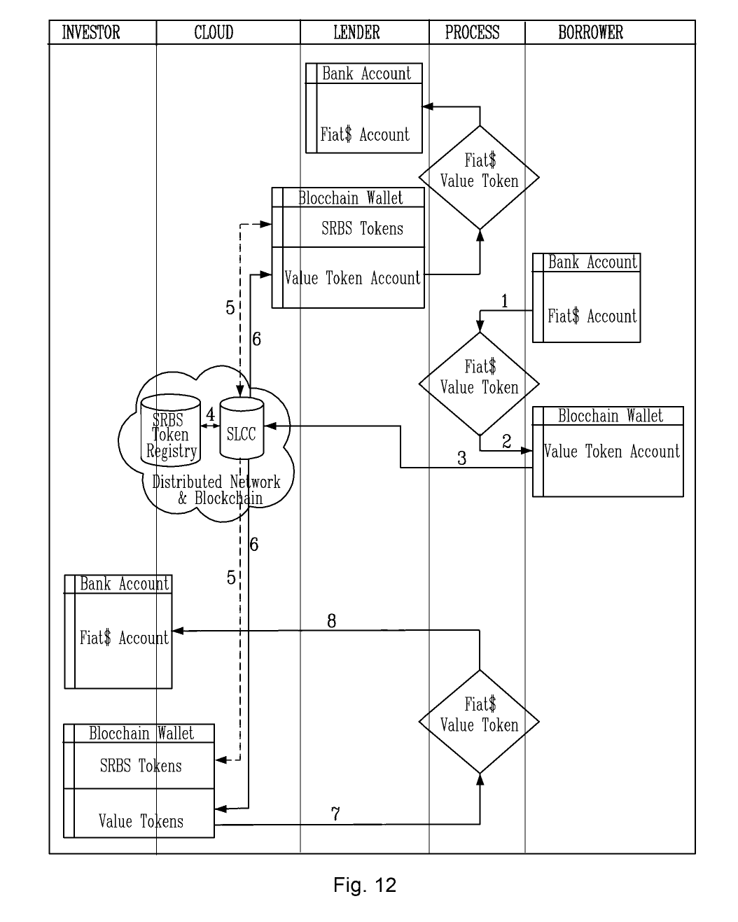

FIG. 12 illustrates a flowchart of the steps involved in the loan repayment process and the block chain trading of tokens.

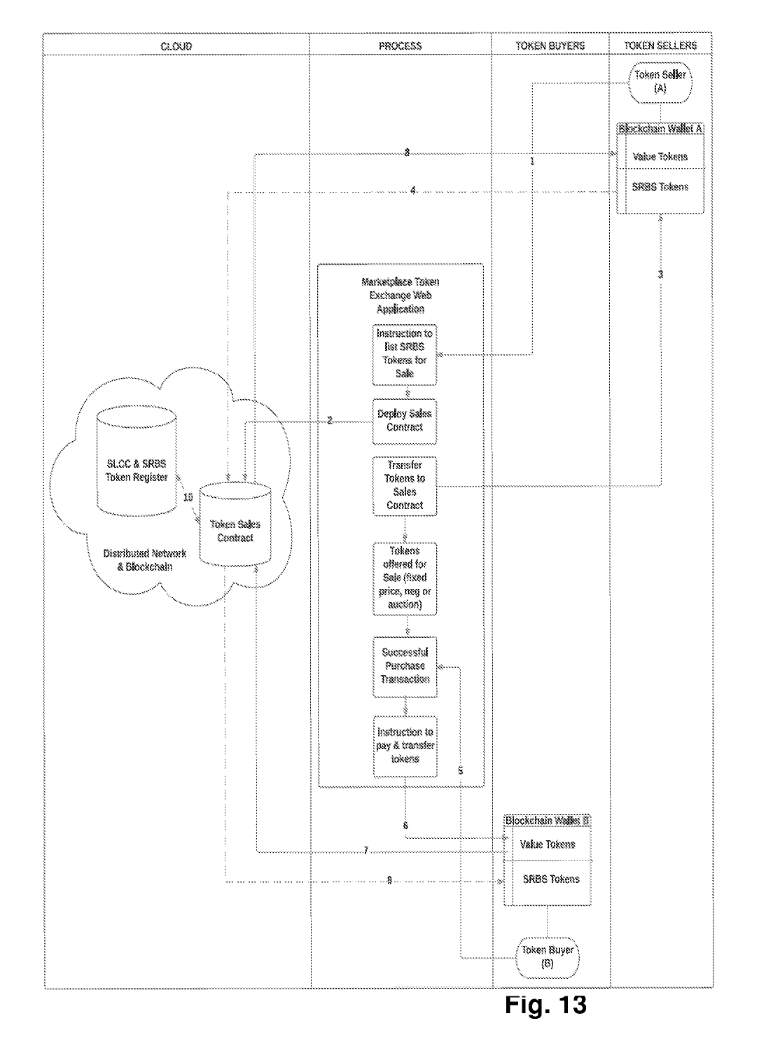

FIG. 13 illustrates the flowchart of the steps involved in the market place exchange of tokens, including the exchange of tokens via a block chain transaction.

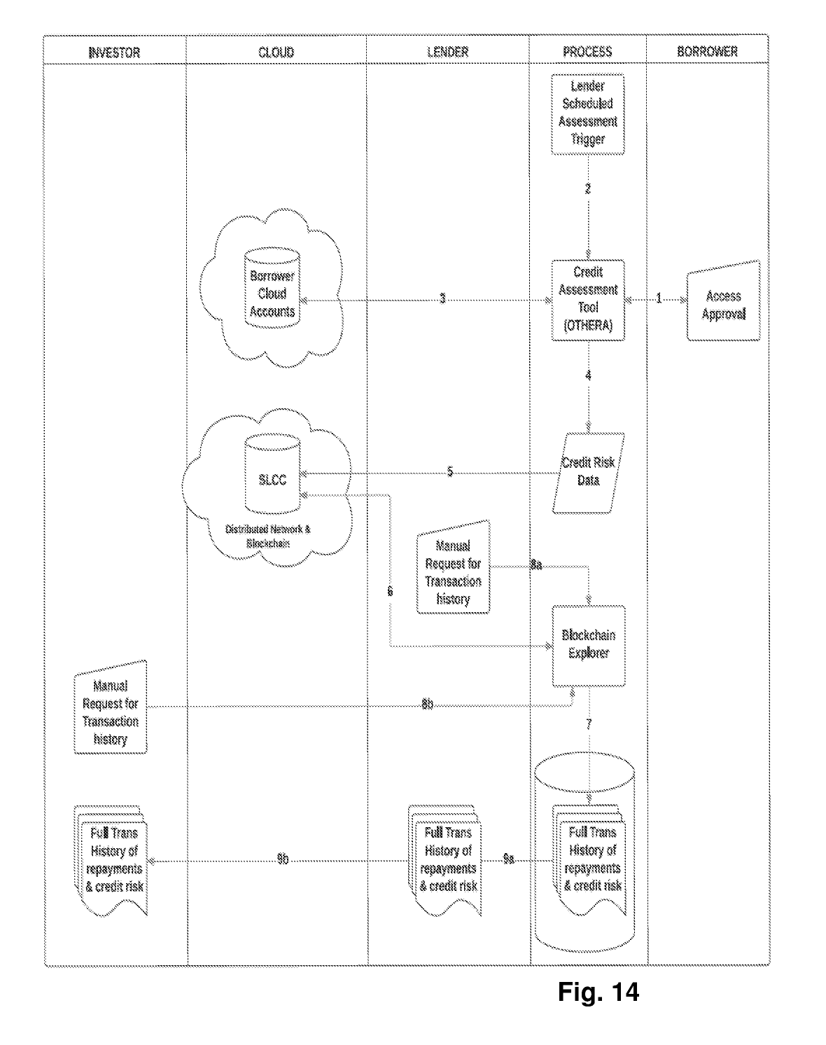

FIG. 14 illustrates the process of dynamic credit risk processing and transaction history reporting.

Control Flow

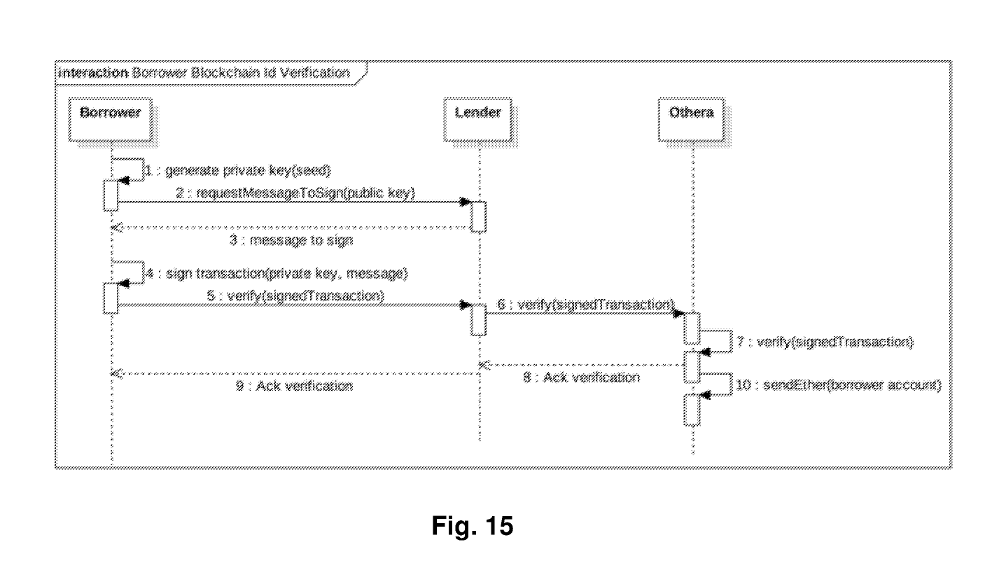

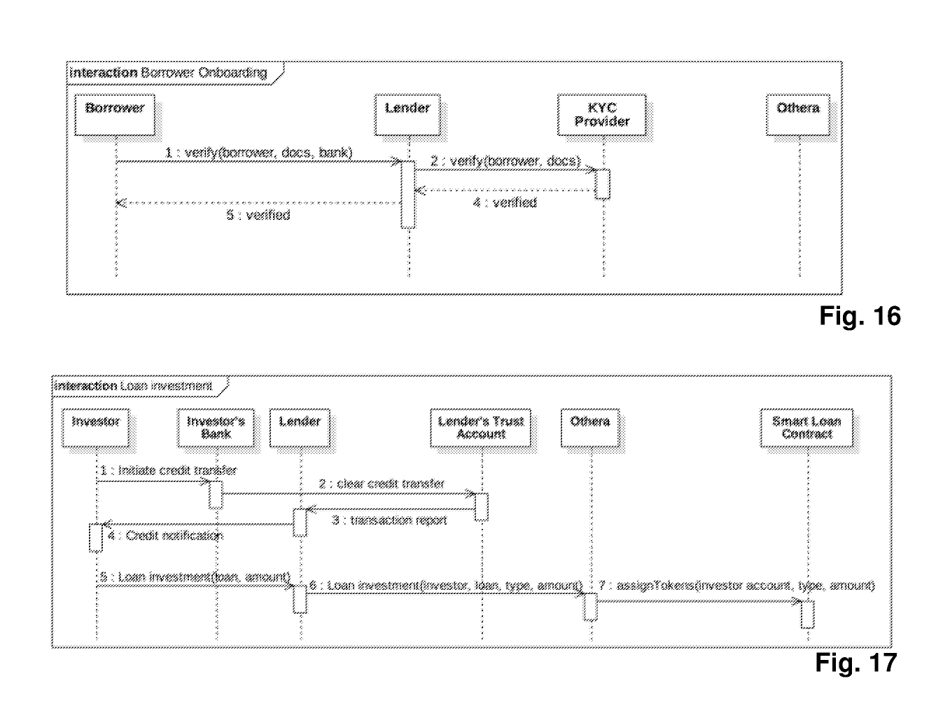

In order to further illustrate the control and network flow of operations, a number of control flow diagrams are provided. For example, FIG. 15 illustrates the control flow for the process of the Interaction process of verifying the borrower identification. This involves a private/public key signing process 241 which is verified by the lender 242 before being validated by the third party exchange provider 243. FIG. 16 illustrates the control flow of of the borrower onboarding process 250 where documents are verified with a third party provider 251.

FIG. 17 illustrates the control flow for a loan investment, including the transfer of funds between investors and lenders.

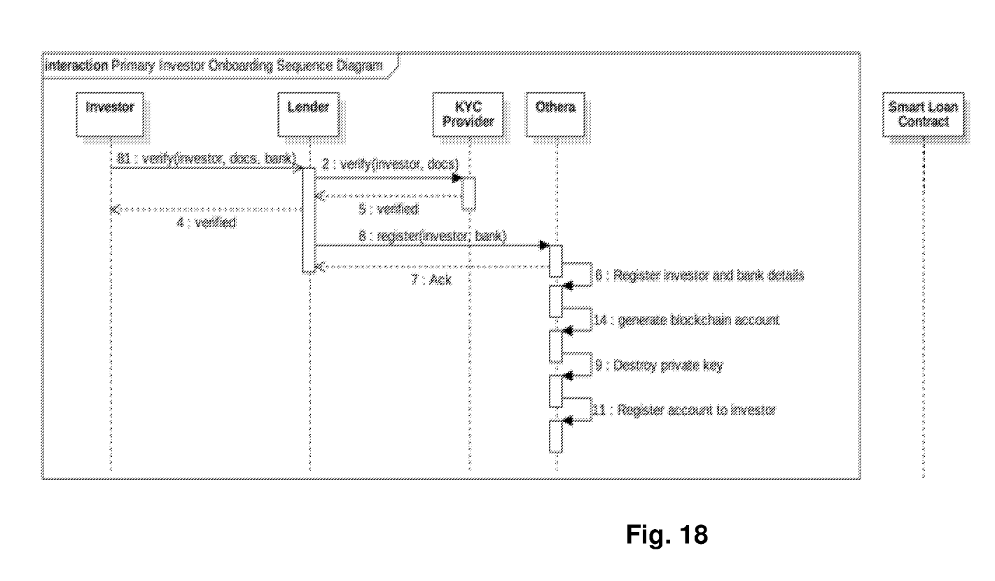

FIG. 18 illustrates the control flow 270 for the process of primary investor onboarding with the third party service provider.

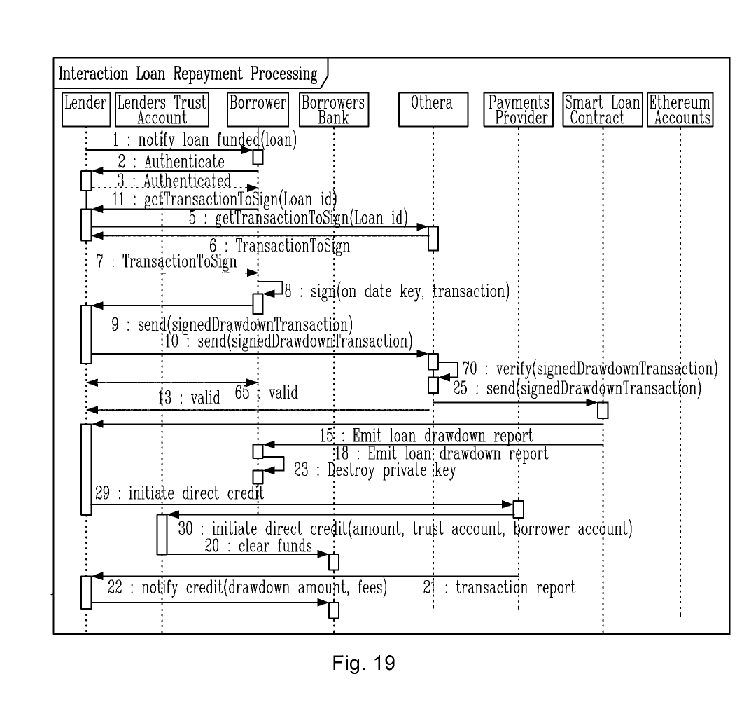

FIG. 19 illustrates the control flow 280 for the process of loan drawdown between lender and borrower.

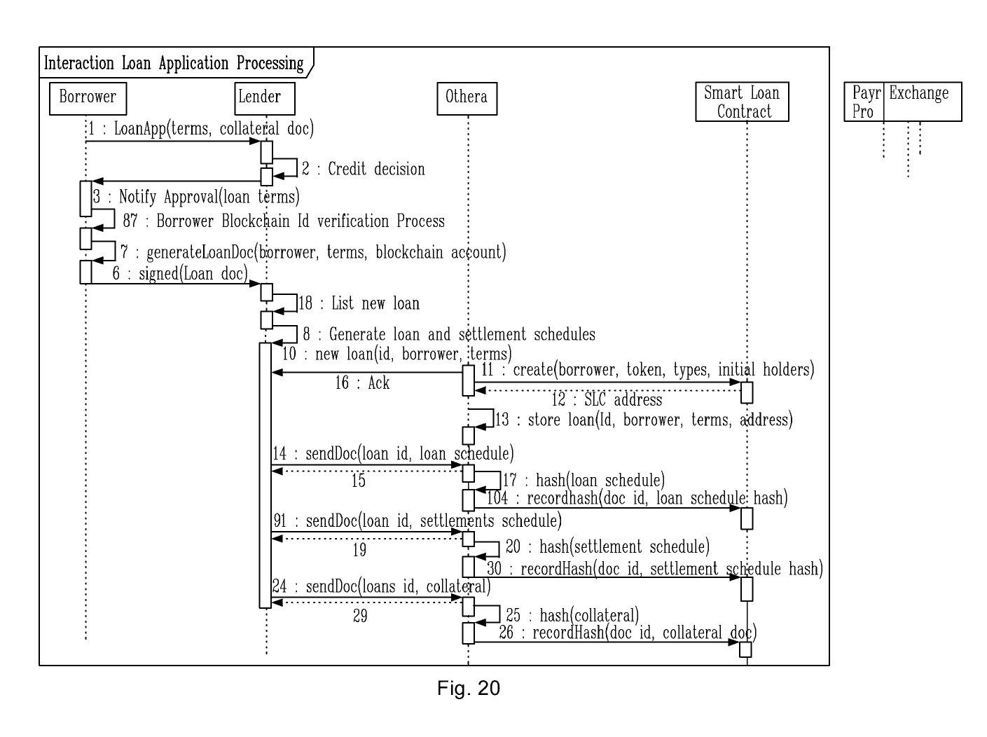

FIG. 20 illustrates the control flow 290 for the process of loan application processing for creating the relevant loan documentation.

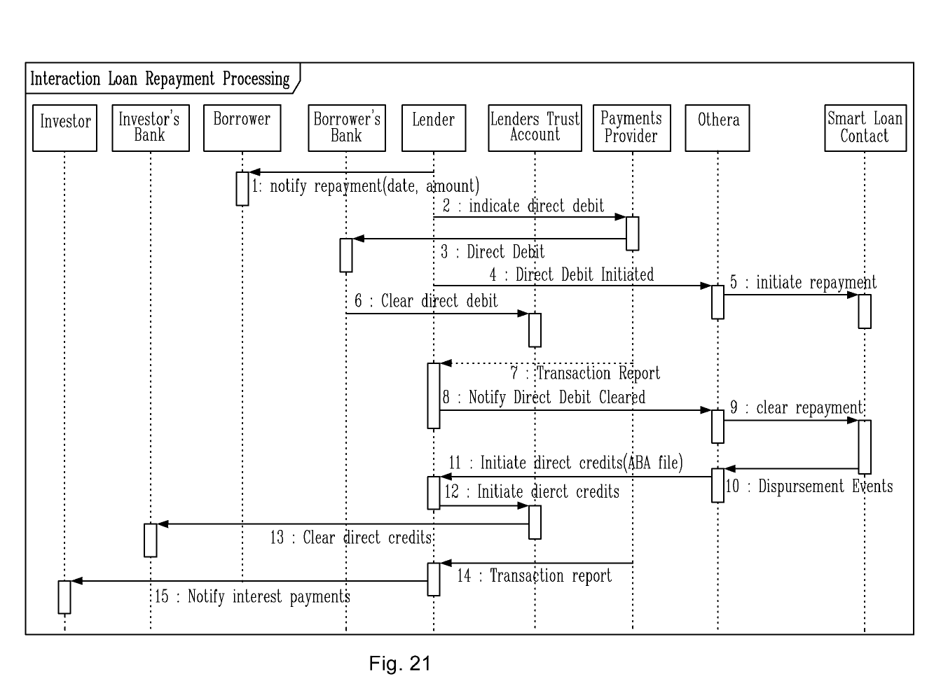

FIG. 21 illustrates the control flow 300 for the process of loan repayment processing of a loan.

Alternate Repayment Modification—Legacy Systems

Further modifications are possible. For example, where it is desired to incorporate legacy payment systems and pre-existing loans into the system, a modified repayment and payment distribution method can be provided to integrate the legacy payment systems into Smart Loan Contracts used to execute the operation of the loan.

More specifically a “receivables management function Loan Management” process can be provided. This can involve taking the repayment notifications from the lender and passing the electronic payment receipt into the blockchain via the Smart Loan Contract. The Smart Loan Contract then executes the calculation and builds a file for the distribution of funds to each of the token holders as per the token register within the Smart Loan Contract. The Smart Loan Contract generated payment file, is then pushed to the external systems of the lender and ultimately the bank to transfer monies to stakeholders.

This allows for the Blockchain platform to integrate and transact with legacy payment and banking systems. This also allows for the payment distributions to all token holders irrespective of whether the token holders are internal customers of the lender or customers external to the lender ie of the token exchange.

Further Alternate Legacy System Operation

Further alternate legacy systems are possible. For example, an alternate to repayment and payment distribution method can involve a Hybrid Value Token & Legacy Payment System.

This alternative refinement accommodates the evolution of the financial ecosystem to incorporate the use of a proprietary value token (blockchain value tokens), which when passed through the Smart Loan Contract, facilitate the calculation of the repayment and payment distribution to token holders without having to accept electronic transaction receipts and pushed notifications from lenders in order to verify transaction events.

This method involves distribution of Value Tokens to the digital wallet of each token holder as the method of execution of the payment distribution. Token holders can either manually trigger the conversion of value tokens back to Fiat currency or have their account set to automatically convert value token to fiat currency during the process.

One method is that a repayment would trigger Value Tokens to be issued by a central clearing entity (one or more clearers per currency) with the Value of the Tokens being backed by the matching value of actual Fiat currency. The issued Value Tokens can be issued directly to the Smart Loan Contract, with the contract calculating the distributions to all token holders for that Loan/Smart Loan Contract.

The Smart Loan Contract would then transfer the appropriate sum of Value Tokens to each of the token holders digital accounts with the clearer exchanging value tokens back for fiat currency, then transferred to token holder's nominated bank accounts. This method would serve as a lead in to the use of state issued Crypto Currencies ie Crypto AUD, USD, GBP, Euro etc.

This would result in a modification of the first embodiment with the borrower making repayments in the local crypto currencies, with these local crypto currencies being passed directly through the Smart Loan Contract for distribution direct to token holders digital wallets with no interaction with legacy banking and payment systems.

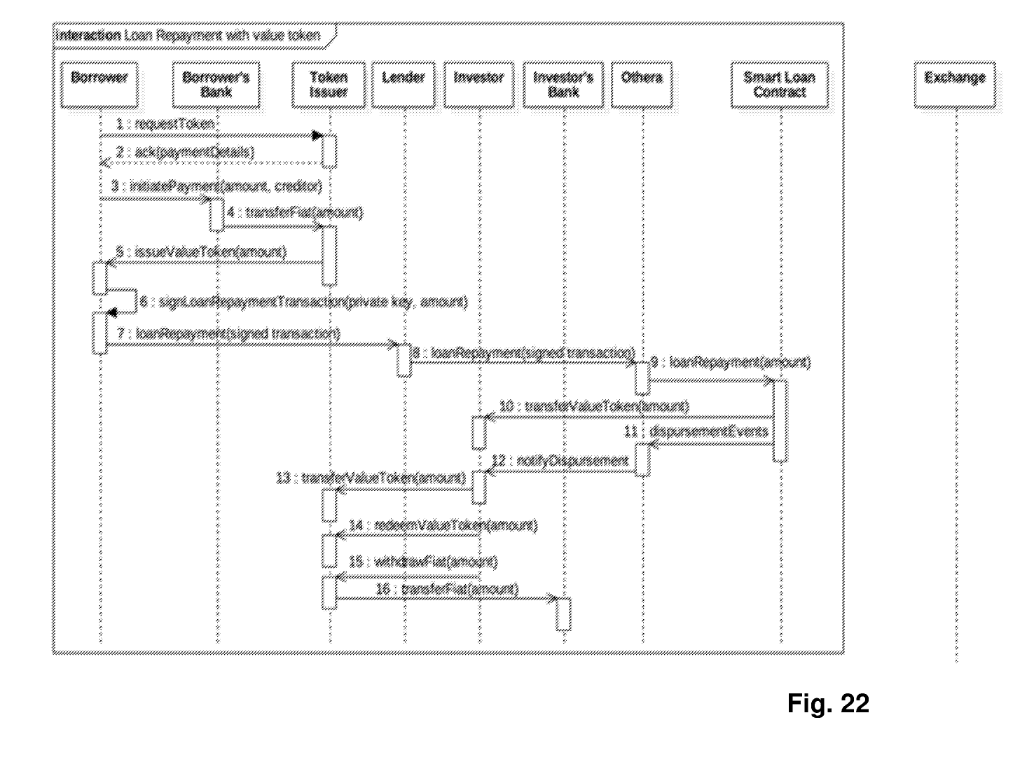

FIG. 22 illustrates one form of transaction flow of loan repayments with a value token in accordance with the above described processing.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of providing for a secure financial transaction, the method including the steps of:
(a) formulating the documentation associated with the financial transaction, including security for the transaction;
(b) dividing the transaction into a series of segments, each segment having an associated expected risk profile and security profile;
(c) for each segment, creating an indicative token describing the segment, including associated expected risk profile and security profile;
(d) providing a block chain environment for storage of said indicative tokens.

2. A method as claimed in claim 1, wherein said step (d) further includes, for each segment, pricing the risk of the segment and then aggregating the pricing to create an aggregate pricing of the financial transaction to the borrower.

3. A method as claimed in claim 1, wherein said step (d) further comprises utilising the block chain environment for the trading of said indicative tokens.

4. A method as claimed in claim 1, wherein step (d) further comprises storing the full transactional history of the transfer of said indicative tokens.

5. A method of providing for a secure financial transaction, the method including the steps of:
(a) formulating the documentation associated with the financial transaction,
(b) creating an encryption hash indicator for the documentation; and
(c) storing the encryption hash indicator in a blockchain as evidence of the transaction.

6. A method as claimed in claim 5, further comprising the step of:
(d) creating a digital signature process for signing the Smart Loan Contract.

7. A financial asset class, denoted a Segmented Risk Based Securities (SRBS), the asset including:
a physical loan of a financial resource;
a physical loan agreement governing the operation of the physical loan; and
a Smart Loan Contract Code to mirror some or all of the executable elements of the physical loan agreement; and
a series of SRBS Tokens (SRBST) stored in a block chain type network representing the rights to the flow of income and principal repayments due under the loan agreement.

8. A financial asset class as claimed in claim 7, wherein said SRBS Tokens are virtual assets backed by physical assets.

9. A financial asset class as claimed in claim 7, wherein said SRBS Tokens represent different segments of risk determined by the level and character of the underlying physical assets used by the borrower to secure the loan.

10. A financial asset class as claimed in claim 9, wherein SRBS tokens represent each discrete risk segment which is priced using any number of risk based pricing methodologies, expressed as an interest rate (IR).

11. A financial asset class as claimed in claim 9, wherein each risk segment is assigned a SRBS token to represent the rights to the flow of income and repayment of principal under the loan agreement.

12. A financial asset class as claimed in claim 7, wherein said SRBS Token is a class of exchange tradable asset.

13. A financial asset class as claimed in claim 7, wherein provision is made for the credit risk of the borrower and loan to be periodically re-assessed over the life of the loan and for that credit risk data to be fed back into the Smart Loan Contract Code where it is tracked and registered on the blockchain as an auditable record of events and view of the credit risk of the investment asset.

14. A financial asset as claimed in claim 13, wherein the financial asset is dynamically re-priced to the borrower based on the change in credit risk.

15. A financial asset class as claimed in claim 7, wherein the full repayment history of the loan is recorded within the Smart Loan Contract Code and registered on a blockchain as an auditable record of the quality of the repayment performance of the borrower.

16. A financial asset class as claimed in claim 7, wherein optional additional data is recorded within the Smart Loan Contract Code.

17. A financial asset class as claimed in claim 7, wherein the attributes of the SRBST's are further securitized or syndicated or both securitized and syndicated to create new SRBS's with tailored risk vs reward profiles.

18. A financial asset as claimed in claim 7, wherein the SRBST can be traded in a primary market direct from Issuer to Investor at a fixed price and also traded in a secondary market environment via a range of methods including but not limited to open supply and demand pricing models or exchanges or direct peer-2-peer or brokered sales.

19. A method of forming a financial asset of the type as claimed in claim 7, the method including the step of:
segmenting the financial asset into risk based segments based on the estimated level and type of assets provided to secure the loan.

20. A method as claimed in claim 19, further including:
funding the escrow function of the Smart Loan Contract code by the lender.

21. A method as claimed in claim 19, further including:
digitally and securely signing the Smart Loan Contract to execute the agreement and trigger the settlement of the loan, within time limited expiry protocols.

22. A method as claimed in claim 19, further including the step of:
automating the creation of loan documents while generating the Smart Contract Loan code in parallel to mirror some or all of the executable terms of the agreement.

23. A method as claimed in claim 19, further comprising the step of:
pricing the notional risk segments and then aggregating the price of each segment to deliver a single price or interest rate for the loan.

24. A method as claimed in claim 19, further including creating cryptographic blockchain tokens (SRBS Tokens) to represent the right to income and capital repayments under the financial asset.

25. A method as claimed in claim 24, wherein the SRBS Tokens represent the right to each risk segment.

26. A method as claimed in claim 24, further comprising utilising a blockchain technology to register and track the ownership of each SRBS token.

27. A method as claimed in claim 19, further comprising calculating and distributing the income and capital repayments to the token holder at each repayment cycle from the borrower.

28. A method as claimed in claim 19, further comprising:
providing for borrowers to transact loan repayments with an SLC Code re the repayment transaction without the need to manage crypto currency accounts and cross currency transactions external to the repayment process.

29. A method as claimed in claim 19 further comprising making an automated fiat currency transaction to pass through either Crypto Currency or a proprietary value token (PVT) then into the SLC Code for re-distribution out to the SRBS Token holders via Crypto Currency or PVT and back into the fiat currency of the SRBS Token holders choice.

30. A method as claimed in claim 19, further comprising providing for the dynamic credit risk assessment of borrowers.

31. A method as claimed in claim 19 further providing for the tracking and recording of the full repayment transactional history of the borrower and loan within the smart loan contract code and blockchain.

32. A method as claimed in claim 19, further comprising managing the exceptions and defaults under the loan agreement with the Smart Loan Contract code.

33. A method as claimed in claim 19, further comprising providing for the amendment of the Loan Agreements once live, using multi signature authentication and blockchain consensus methodology.
